(19) United States
(12) Patent Application Publication
(10) Pub. No.: US 2006/0109678 A1
(43) Pub. Date: May 25, 2006

(54) Christmas lamp with a plurality of bulbs

(76) Inventor: Wen Pin Chuang, Hsin Chu City (TW)

Correspondence Address: WEN PIN CHUANG, 235 Chung - Ho, Box 8-24, Taipei, TW

(21) Appl. No.: 10/994,931

(22) Filed: Nov. 23, 2004

(51) Int. Cl. F21V 7/04; F21S 4/00

(52) U.S. Cl. 362/565; 362/806

(57) ABSTRACT

A Christmas lamp with a plurality of bulbs comprises a plurality of bubbles; each bulb having two legs; a bulb seat; the bulb seat being installed with a plurality of slots for receiving a plurality of bulbs; the legs of two bulbs being connected in parallel; a base; the base being connected to the bulb seat; the base having a plurality of metal plates for contacting and conducting the legs. One Christmas lamp has a plurality of bulbs. A buckling plate is extended from one lateral side of the bulb seat; the buckling plate has a concave portion which is bendable; a distal end of the buckling plate has a guide inclined surface and a hook; one lateral side of the base has a buckle for receiving the buckling plate. The lights emitting from the bulbs are different.

### FIELD OF THE INVENTION

The present invention relates to Christmas lamps, and particularly to a Christmas lamp with a plurality of bulbs, wherein bulbs in the Christmas lamp are connected in parallel and thus the damage of on bulb will not affect the operation of the whole Christmas lamp series. Moreover, shorter length than that needed in the prior art is achieved as the number of the bulbs is equal to the bulbs prior art used. Thereby the cost is down.

### BACKGROUND OF THE INVENTION

With reference to FIG. 1, a prior art Christmas lamp is illustrated. The Christmas lamp 1 is formed with a bulb 11, a bulb seat 12 and a base 13. The bulb 11 is firstly inserted into the bulb seat 12. Finally, the bulb seat 12 is assembled to the base 13. Referring to FIG. 2, a conventional Christmas lamp series 19 is formed by serially connecting a plurality of Christmas lamps 1, for example, 100 Christmas lamps are serially connected. However the great the number of the lamps, the longer the wires necessary. As a result, cost is increased. Furthermore, since in the Christmas lamp series 19, all the lamps are connected in series, once one lamp is damaged, the whole Christmas lamp series 19 will not light up. The whole Christmas lamp series 19 will be deserted, or the lamps must be checked one by one for finding the wrong one. This will increase the cost and induce inconvenience in operation.

### SUMMARY OF THE INVENTION

Accordingly, the primary object of the present invention is to provide a Christmas lamp with a plurality of bulbs, wherein bulbs in the Christmas lamp are connected in parallel and thus the damage of on bulb will not affect the operation of the whole Christmas lamp series.

Another object of the present invention is to provide a Christmas lamp with a plurality of bulbs, wherein shorter length than that needed in the prior art is necessary as the number of the bulbs is equal to the bulbs prior art used. Thereby the cost is down.

A further object of the present invention is to provide a Christmas lamp with a plurality of bulbs, wherein one bulb seat has two bulbs and thus the damage bulb can be found easily so that the maintenance work is performed rapidly and easily.

To achieve above objects, the present invention provides a Christmas lamp with a plurality of bulbs which comprises a plurality of bubbles; each bulb having two legs; a bulb seat; the bulb seat being installed with a plurality of slots for receiving a plurality of bulbs; the legs of two bulbs being connected in parallel; a base; the base being connected to the bulb seat; the base having a plurality of metal plates for contacting and conducting the legs. One Christmas lamp has a plurality of bulbs. A buckling plate is extended from one lateral side of the bulb seat; the buckling plate has a concave portion which is bendable; a distal end of the buckling plate has a guide inclined surface and a hook; one lateral side of the base has a buckle for receiving the buckling plate. The light emitting from the bulbs are different.

The various objects and advantages of the present invention will be more readily understood from the following detailed description when read in conjunction with the appended drawing.

### BRIEF DESCRIPTION OF THE DRAWINGS

FIG. 1 is a perspective view of a prior art Christmas lamp.

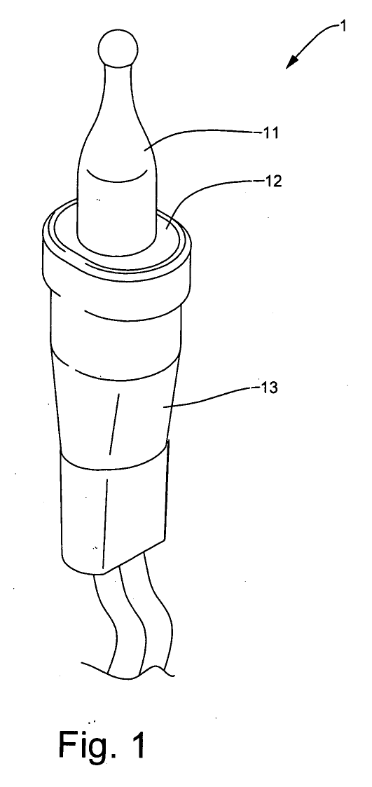

FIG. 2 is a schematic view showing the prior art Christmas lamp series.

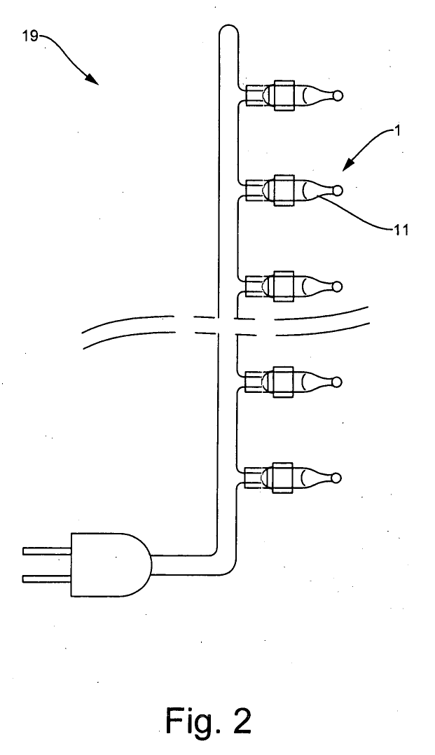

FIG. 3 is a perspective view of the present invention.

FIG. 4 is an exploded perspective view of the present invention.

FIG. 5 is a schematic cross view of the present invention.

FIG. 6 is another schematic view of the present invention.

FIG. 7 is a schematic view about the Christmas lamp series according to the present invention.

FIG. 8 is a schematic view about the combination of the bulb seat and the base of the present invention.

FIG. 9 is a partial enlarged schematic view about another embodiment of the press buckle of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

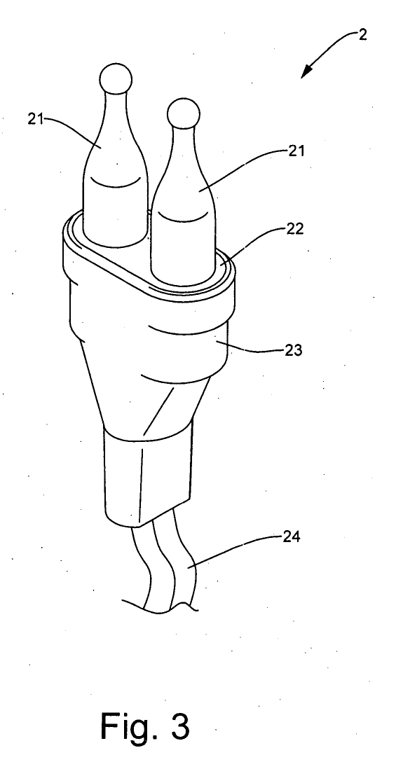

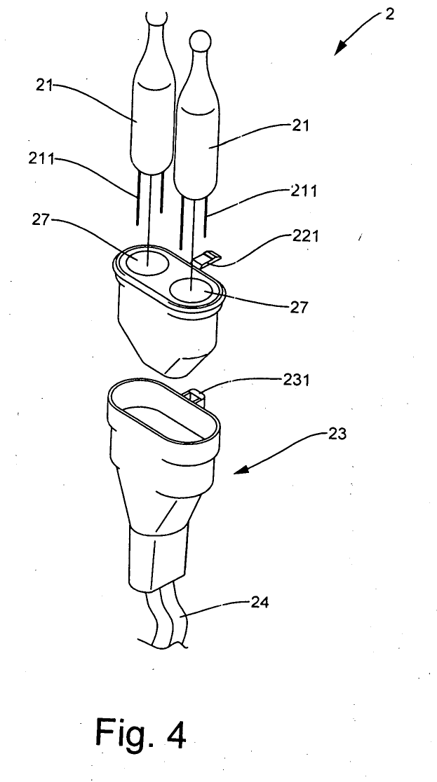

Referring to FIGS. 3 and 4, Christmas lamp with a plurality of bulbs of the present invention is illustrated. The Christmas lamp 2 of the present invention includes two bulbs 21, a bulb seat 22, and a base 23. A portion of the Christmas lamp 2 is connected to power wires 24. In this embodiment, two bulbs 2 are used as an example, however the number of bulbs is not confined by two, other numbers are permissible.

Each bulb 21 has two legs 211.

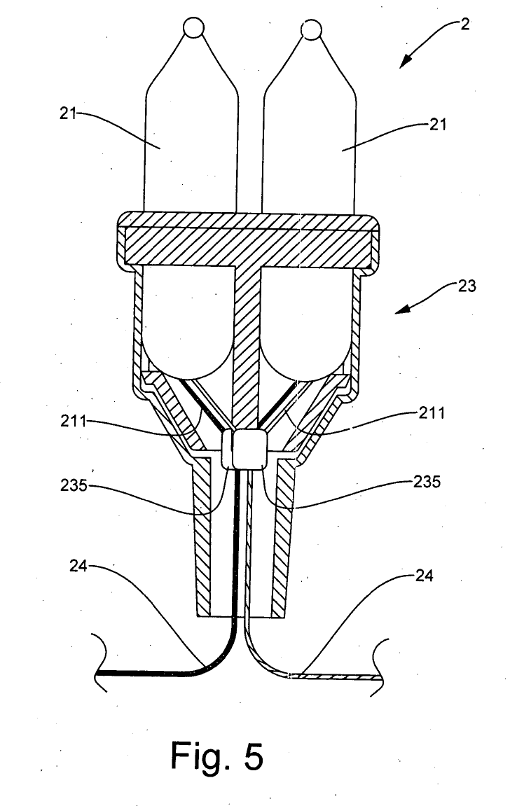

The bulb seat 22 is installed with two slots 27 for receiving the two bulbs 21. The legs 211 of two bulbs 21 are connected in parallel, as shown in FIG. 5.

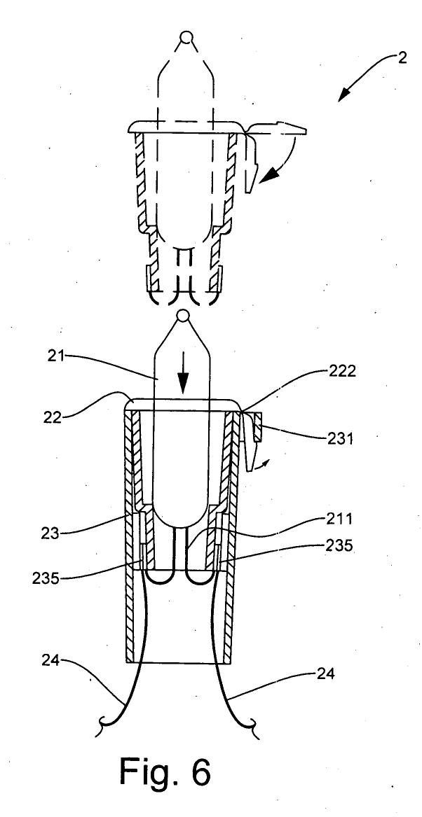

The base 23 is connected to the bulb seat 22. The base 23 has two metal plates 235 for contacting and conducting the legs 211, as shown in FIG. 6.

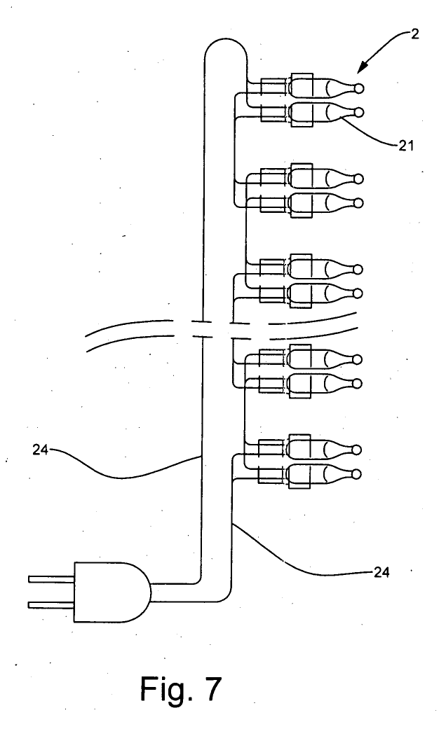

By above mentioned structure, one Christmas lamp 2 has two bulbs 21, one bulb seat 22 and one base 23. In application, see FIG. 7, under the condition of not increasing the length of wires, the number of the bulbs are doubled. Only the cost of one bulb 21 is increased, but it is very low. Besides, in the present invention, the colors of two bulbs can be different. Furthermore, in the present invention, the legs are connected in parallel, the damage of on bulb will not affect the operation of the whole Christmas lamp series.

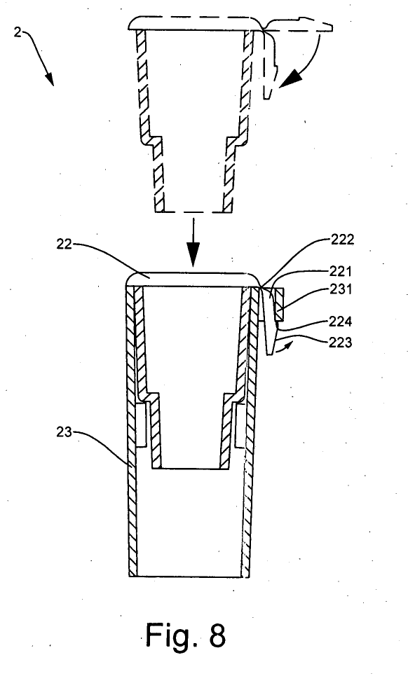

With reference to FIGS. 4 and 8, to firmly secure the bulb seat 22 to the base 23, a buckling plate 221 is extended from one lateral side of the bulb seat 22. The buckling plate 221 has a concave portion 222 which is bendable. A distal end of the buckling plate 221 has a guide inclined surface 223 and a hook 224. One lateral side of the base 23 has a buckle 231 for receiving the buckling plate 221. Thereby when it is desired to combine the bulb seat 22 with the base 23, it is only necessary to insert the bulb seat 22 slowly into the base 23. Meanwhile, the buckling plate 221 bends downwards. Next, the guide inclined surface 223 of the buckling plate 221 is inserted into the buckle 231. Finally, when the bulb seat 22 is wholly combined with the base 23, the buckling plate 221 will apply an elastic force so that the hook 225 thereof will completely combine the buckle 231.

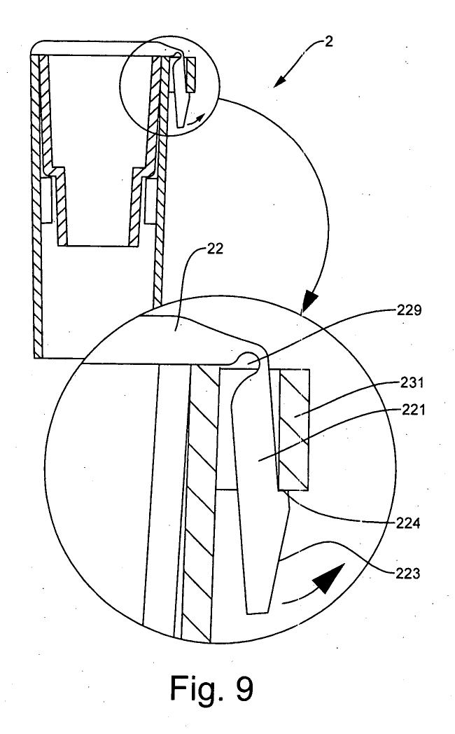

With reference to FIG. 9, another embodiment of the present invention is illustrated, where the concave portion 222 of the buckling plate 221 is replaced by a concave portion 229 at a bottom of the buckling plate 221.

It should be noted that in above description example, only two bulbs are used as example. However in the present invention, the number of the bulbs is not confined by two, the number greater than two are permissible.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A Christmas lamp with a plurality of bulbs comprising:
a plurality of bubbles; each bulb having two legs;
a bulb seat; the bulb seat being installed with a plurality of slots for receiving a plurality of bulbs; the legs of bulbs being connected in parallel;
a base; the base being connected to the bulb seat; the base having a plurality of metal plates for contacting and conducting the legs;
whereby one Christmas lamp has a plurality of bulbs.

2. The Christmas lamp with a plurality of bulbs as claimed in claim 1, wherein there are two bulbs are used in the Christmas lamp.

3. The Christmas lamp with a plurality of bulbs as claimed in claim 1, wherein a buckling plate is extended from one lateral side of the bulb seat; the buckling plate has a concave portion which is bendable; a distal end of the buckling plate has a guide inclined surface and a hook; one lateral side of the base has a buckle for receiving the buckling plate.

4. The Christmas lamp with a plurality of bulbs as claimed in claim 1, wherein the light emitting from the bulbs are different.
